(19) United States
(12) Patent Application Publication
(10) Pub. No.: US 2007/0025666 A1
(43) Pub. Date: Feb. 1, 2007

(54) Optical connector plug

(75) Inventors: Masahiro Shibata, Chigasaki-shi (JP); Masakazu Shigehara, Chigasaki-shi (JP)

Correspondence Address: MCDERMOTT WILL & EMERY LLP, 600 13TH STREET, N.W., WASHINGTON, DC, 20005-3096, US

(73) Assignee: SUMIDEN HIGH PRECISION CO., LTD.

(21) Appl. No.: 11/494,728

(22) Filed: Jul. 28, 2006

Related U.S. Application Data
(60) Provisional application No. 60/703,008, filed on Jul. 28, 2005.

(51) Int. Cl. G02B 6/36; G02B 6/38

(52) U.S. Cl. 385/78; 385/76; 385/77; 385/86; 385/55; 385/56; 385/58; 385/60; 385/141

(57) ABSTRACT

An optical connector plug inserted into a receptacle of an optical communication module, having: an optical fiber; a ferrule having a tubular form, the optical fiber being provided in an inner hole of the ferrule; and a housing which is fitted into the receptacle, the optical fiber and the ferrule passing through the interior of the housing, wherein either one of at least a part of the housing and at least a part of the ferrule is made of an electromagnetic wave absorption material.

### CROSS-REFERENCE TO RELATED APPLICATION

This application claims priority to Provisional Application filed on Jul. 28, 2005 by the same Applicant, which is hereby incorporated by reference in its entirety.

### BACKGROUND OF THE INVENTION

1. Field of the Invention

The present invention relates to an optical connector plug.

2. Related Background Art

An optical communication module comprises an optical transmission sub-assembly, an optical reception sub-assembly, a circuit board, a receptacle, and a casing. The optical transmission sub-assembly comprises a light-emitting element for generating light. The optical reception sub-assembly comprises a light-receiving element for receiving light. The circuit board carries a driver IC and so on, and is electrically connected to the light-emitting element and light-receiving element. The casing is provided to cover the optical transmission sub-assembly, optical reception sub-assembly, and circuit board. The receptacle comprises opening portions for optically coupling optical fibers to each of the light-emitting element and light-receiving element. An optical connector plug holding an optical fiber is inserted into the opening portion in the receptacle. A metallic casing is used in this type of optical communication module to prevent the emission of electromagnetic waves to the outside. This technology is disclosed in Japanese Unexamined Patent Application Publication No. 2004-212709, for example.

### SUMMARY OF THE INVENTION

However, with the optical communication module described above, electromagnetic waves are emitted to the outside through the opening portion in the receptacle and so on. Moreover, when the optical connector plug is inserted into the receptacle, faint electromagnetic waves may be subjected to stimulated emission from the interior of the optical communication module by the metallic components in the interior of the optical connector plug.

An object of the present invention is to provide an optical connector plug and an optical connector device which are capable of suppressing electromagnetic wave emission from an optical communication module.

An optical connector plug of the present invention is inserted into a receptacle of an optical communication module. The optical connector plug comprises an optical fiber, a ferrule, and a housing. The ferrule has a tubular form, and the optical fiber is provided in an inner hole thereof. The optical fiber and ferrule pass through the interior of the housing, and the housing is fitted into the receptacle. In this optical connector plug, at least a part of the housing or at least a part of the ferrule is comprised of an electromagnetic wave absorption material.

An optical connector device of the present invention comprises: the first optical connector plug of the present invention; the second optical connector plug of the present invention; and an adapter connecting and holding the first optical connector plug and the second optical connector plug, wherein the adapter is comprised of an electromagnetic wave absorption material.

### BRIEF DESCRIPTION OF THE DRAWINGS

FIG. 1 is a perspective view of an optical connector plug according to an embodiment of the present invention.

FIG. 2 is an exploded perspective view of the optical connector plug according to the embodiment of the present invention.

FIG. 3 is a sectional view along a line III-III indicated by the arrow in FIG. 1.

FIG. 4 is a sectional view showing a state in which the optical connector plug shown in FIG. 3 is fitted into an optical communication module.

FIG. 5 is a perspective view of an optical connector device according to an embodiment of the present invention.

FIG. 6 is an exploded perspective view of the optical connector device according to the embodiment of the present invention.

### DESCRIPTION OF THE PREFERRED EMBODIMENTS

A preferred embodiment of the present invention will be described in detail below with reference to the drawings. Note that identical reference symbols have been allocated to identical or corresponding parts in each of the drawings.

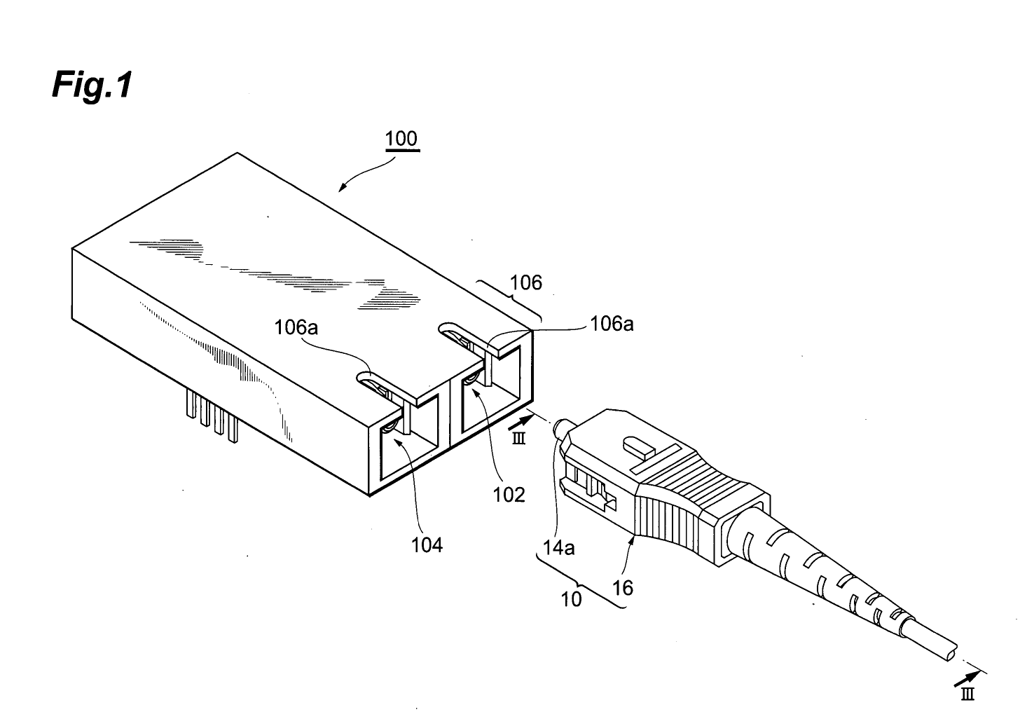

FIG. 1 is a perspective view of an optical connector plug according to an embodiment of the present invention. In FIG. 1, an optical communication module is illustrated together with the optical connector plug. An optical connector plug 10 shown in FIG. 1 is used to transmit an optical signal from an optical communication module 100 or to transmit an optical signal from the outside to the optical communication module 100. Note that the optical connector plug according to this embodiment is an SC type optical connector plug, but the present invention is not limited to an SC type optical connector plug, and may be applied similarly to an MU type or LC type optical connector plug.

The optical communication module 100 comprises an optical transmission sub-assembly 102, an optical reception sub-assembly 104, and a receptacle 106. The optical transmission sub-assembly 102 is a device for outputting an optical signal, and comprises a light-emitting element such as a semiconductor laser. The optical reception sub-assembly 104 is a device for receiving an optical signal, and comprises a light-receiving element such as a photodiode.

The optical communication module 100 further comprises a circuit board carrying a driver IC and the like for driving the light-emitting element. Hence, the optical communication module 100 generates electromagnetic waves from the internal elements thereof or from wiring and so on. To reduce the emission of these electromagnetic waves to the outside, the optical communication module 100 uses a metallic material which blocks electromagnetic waves for a casing or the like constituting the outer shell thereof.

The receptacle 106 comprises an outer wall defining two holes. The optical transmission sub-assembly 102 and optical reception sub-assembly 104 are housed respectively in the two holes. The optical connector plug 10 is fitted into these holes in the receptacle 106. As a result, an optical fiber of the optical connector plug 10 is optically coupled to the light-emitting element of the optical transmission sub-assembly 102 or the light-receiving element of the optical reception sub-assembly 104.

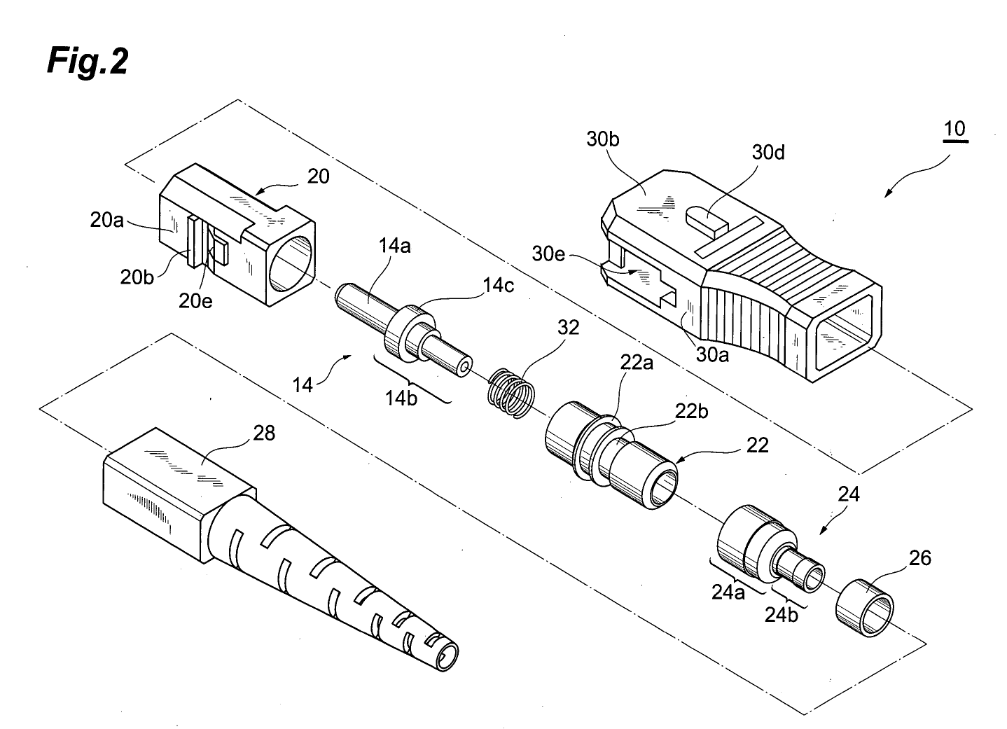

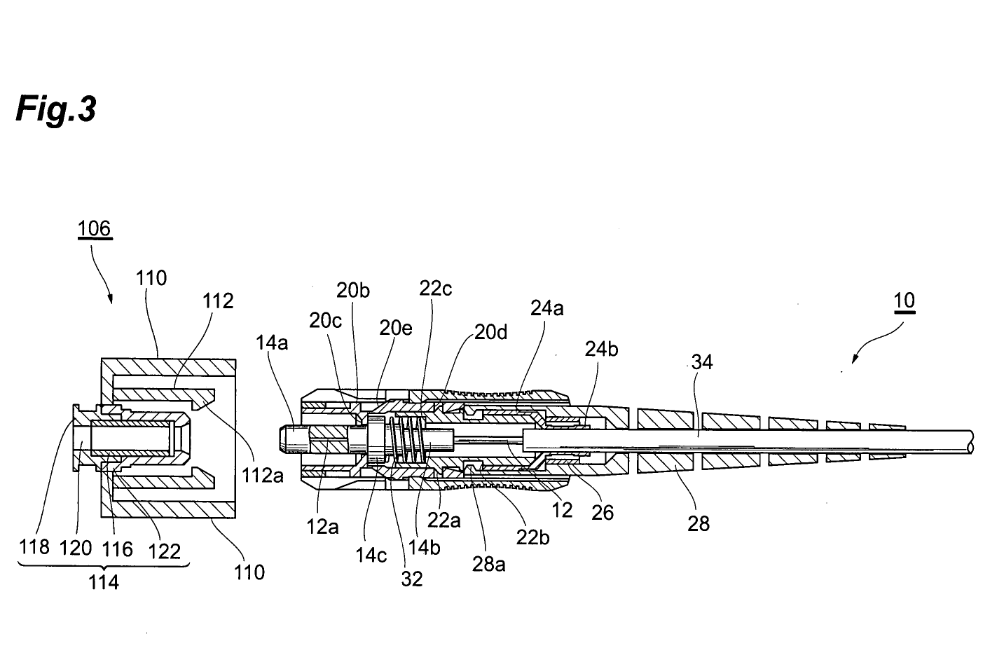

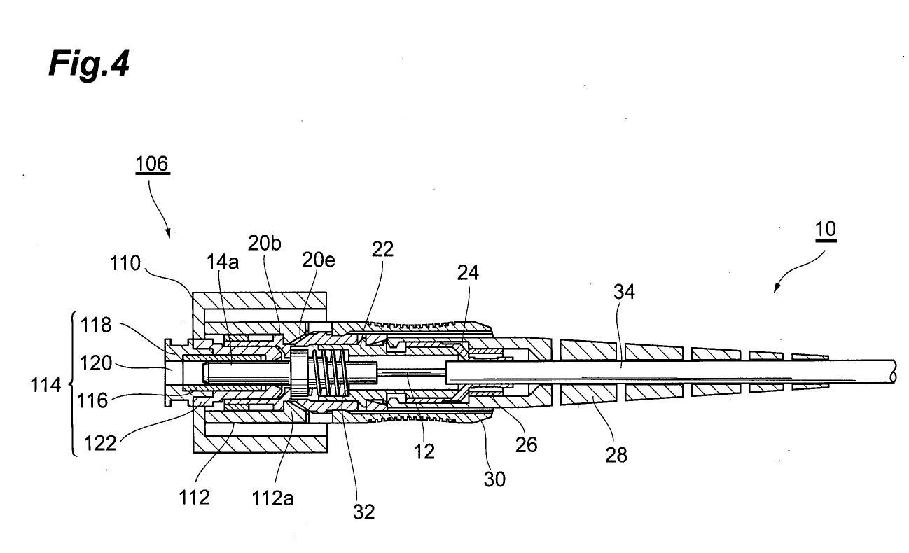

The optical connector plug 10 according to this embodiment will now be described in further detail. FIG. 2 is an exploded perspective view of the optical connector plug according to this embodiment of the present invention. FIG. 3 is a sectional view along a line III-III indicated by the arrow in FIG. 1. FIG. 4 is a sectional view showing a state in which the optical connector plug shown in FIG. 3 is fitted into an optical communication module.

As shown in FIGS. 1 to 4, the optical connector plug 10 comprises an optical fiber core wire 12, a ferrule 14, and a housing 16.

The optical fiber core wire 12 covers an optical fiber 12a (see FIG. 3). The optical fiber core wire 12 is held by the ferrule 14.

The ferrule 14 comprises a ferrule core 14a and a flange portion 14b. The ferrule core 14a is a substantially cylindrical member. The optical fiber 12a passes through the inner hole in the ferrule core 14a. The ferrule core 14a of this embodiment is made of nickel(Ni). Note that the ferrule core 14a may be comprised of a ceramic such as zirconia.

The flange portion 14b has a substantially cylindrical form. The flange portion 14b may be a metallic or resin member, but is preferably made of a resin having an electromagnetic wave absorption function. This resin material will be described in further detail below.

The flange portion 14b is provided co-axially with the ferrule core 14a. The flange portion 14b comprises at one end side thereof a flange 14c having a larger diameter than the other part. The flange portion 14b holds a base end portion of the ferrule core 14a which is inserted into an inner hole in the end side of the flange portion 14b. The optical fiber core wire 12 passes through the inner hole in the flange portion 14b and extends from an opening in the other end of the flange portion 14b.

The housing 16 covers the optical fiber core wire 12 and ferrule 14. The housing 16 comprises a plug frame 20, a stop ring 22, a first ring 24, a second ring 26, a boot 28, and a cover 30.

The plug frame 20 is a tubular member. The plug frame 20 comprises a pair of side faces 20a. Each of the pair of side faces 20a includes a protruding portion 20b. The protruding portion 20b extends in a vertical direction in relation to the axis of the plug frame 20. The side face 20a also includes an opposing surface 20e which opposes one surface of the protruding portion 20b.

The plug frame 20 further comprises an annular portion 20c which defines a hole having a smaller diameter than the other parts thereof in the axial direction of the plug flame 20. In other words, the annular portion 20c extends inside in annular form toward the axis.

The ferrule core 14a passes through an inner hole extending from the annular portion 20c to one end of the plug frame 20. The flange portion 14b passes through an inner hole extending from the annular portion 20c to the other end of the plug frame 20. A groove 20d is formed on an inner wall surface of the plug frame 20 defining the inner hole on the other end side. One end side of the stop ring 22 is inserted into the inner hole on the other end side of the plug frame 20.

The stop ring 22 is a substantially cylindrical member. The stop ring 22 is provided co-axially with the plug frame 20. The stop ring 22 comprises a collar-shaped portion 22a. The collar-shaped portion 22a extends outside in annular form around the stop ring 22. The collar-shaped portion 22a is inserted into the groove 20d of the plug frame 20. Thus the stop ring 22 is latched to the plug frame 20.

A groove 22b is formed in an outer wall surface of the stop ring 22 further toward the other end side than the collar-shaped portion 22a. The stop ring 22 further comprises a large diameter inner hole and a small diameter inner hole in the axial direction thereof. A stepped surface 22c positioned at the boundary between the large diameter inner hole and the small diameter inner hole opposes one surface of the annular portion 20c of the plug frame 20. The flange 14c and a spring 32 are provided between this surface of the annular portion 20c and the stepped surface 22c.

The spring 32 is a metallic coil spring. The flange portion 14b passes through the inside of the spring 32. One end of the spring 32 abuts against the stepped surface 22c. The other end of the spring 32 abuts against the flange 14c. The urging force generated by the spring 32 causes the flange 14c to abut against one surface of the annular portion 20c.

The first ring 24 is attached to the other end side of the stop ring 22. The first ring 24 is a substantially cylindrical member provided co-axially with the stop ring 22. The first ring 24 is metallic, and may be formed from an aluminum alloy, for example.

The first ring 24 comprises a large diameter portion 24a and a small diameter portion 24b sequentially in the axial direction of the first ring 24. The other end side of the stop ring 22 is fitted into an inner hole in the large diameter portion 24a.

The optical fiber core wire 12 covered by a tube 34 passes through the inner hole in the first ring 24. The small diameter portion 24b of the first ring 24 tightens the tube 34 to the optical fiber core wire 12.

The second ring 26 is provided so as to cover the small diameter portion 24b of the first ring 24. The second ring 26 is a cylindrical member provided co-axially with the small diameter portion 24b of the first ring 24. The second ring 26 is metallic, and may be formed from a copper alloy, for example.

The boot 28 is provided so as to cover the first ring 24 and the second ring 26. The optical fiber core wire 12 covered by the tube 34 passes through the inside of the boot 28.

A claw 28a is provided at the end of the boot 28. The claw 28a is inserted into the groove 22b of the stop ring 22 such that the boot 28 is latched to the stop ring 22.

The cover 30 is a tubular member provided so as to cover the plug frame 20, stop ring 22, first ring 24, second ring 26, and a part of the boot 28.

The cover 30 comprises a pair of side walls 30a, an upper wall 30b which extends along a plane that intersects the side walls 30a, and a lower wall which opposes the upper wall 30b. A protrusion 30d is provided on the upper wall 30b. When the optical connector plug 10 is inserted into the receptacle 106, the protrusion 30d is guided along a groove 106a in the receptacle 106 (see FIG. 1). Note that the groove 106a is provided in the outer wall of the receptacle 106 at a predetermined length from the open end.

The side walls 30a of the cover 30 are each provided with a groove 30e. The protruding portion 20b of the plug frame 20 is inserted into the groove 30e.

Of the housing 16 comprised as described above, in this embodiment the plug frame 20, stop ring 22, and cover 30 are comprised of a material having an electromagnetic wave absorption function. The flange portion 14b is also comprised of a material having an electromagnetic wave absorption function. Note that the boot 28 and tube 34 may also be comprised of a material having an electromagnetic wave absorption function.

A material containing resin as a main raw material and an additive having electromagnetic wave absorbency may be used as a material having electromagnetic wave absorbency. Examples of the resin include nylon resin, PBT resin, PPS resin, LCP resin, PEEK resin, and epoxy resin.

As the additive, a fine powder of iron, a fine powder of aluminum, a fine powder of cobalt, a fine powder of silicon, a fine powder of iron oxide, a fine powder of carbon, or a fine powder of stainless steel may be used. Alternatively, a fine powder of an alloy containing two or more materials selected from iron, aluminum, cobalt, and silicon may be used as the additive. These additives are capable of absorbing electromagnetic waves by converting the electromagnetic waves into heat.

The optical connector plug 10 is capable of suppressing electromagnetic waves generated by the optical communication module 100. The structure of the receptacle 106 of the optical communication module 100 to which the optical connector plug 10 is attached will now be described in detail.

As illustrated in FIGS. 3 and 4, the receptacle 106 comprises an outer wall 110 which defines the hole for inserting the optical connector plug 10. The outer wall 110 is made of metal or resin having a metal film formed on its surface.

A pair of latching members 112 extending in the axial direction of the receptacle 106 are provided in the interior of the receptacle 106. A claw 112a is provided at the tip end of each latching member 112. When the optical connector plug 10 is inserted into the receptacle 106, the claw 112a is inserted between one surface of the protruding portion 20b and the opposing surface 20e of the plug frame 20, and thereby latches the optical connector plug 10.

In the receptacle 106, a sleeve assembly 114 of one of the optical transmission sub-assembly 102 and the optical reception sub-assembly 104 is inserted into one of the openings in the outer wall 110. The sleeve assembly 114 seals one of the openings in the outer wall 110.

The sleeve assembly 114 comprises a first sleeve 116, a bush 118, a stub 120, and a second sleeve 122. The first sleeve 116 is a cylindrical member possessing elasticity in the diametrical direction. The first sleeve 116 is formed from a ceramic. The ferrule core 14a is inserted into an inner hole in the first sleeve 116.

The bush 118 is a cylindrical member, and a base end portion of the first sleeve 116 is fitted into an inner hole of the bush 118. A part of the stub 120 is inserted into the base end portion of the first sleeve 116. The bush 118 also holds a base end portion of the stub 120. The stub 120 holds an optical fiber.

The second sleeve 122 is a cylindrical member covering the first sleeve 116 and a part of the bush 118. The second sleeve 122 and bush 118 are metallic members which seal one of the openings in the outer wall 110.

When the optical connector plug 10 is inserted into the hole in the receptacle 106 structured described above, the ferrule core 14a is fitted into the first sleeve 116. As a result, the optical fiber of the stub 120 is optically coupled to the optical fiber 12a held in the ferrule core 14a.

Simultaneously, the opening in the receptacle 106 is sealed by the housing 16. The plug frame 20, stop ring 22, and cover 30 of the housing 16 have an electromagnetic wave absorption function, and hence the opening in the receptacle 106 is also sealed electromagnetically. Thus the emission of electromagnetic waves from the receptacle 106 is suppressed.

Further, a metallic component of the optical connector plug 10 such as the spring 32 is covered by the plug frame 20, stop ring 22, and cover 30 which have an electromagnetic wave absorption function. Hence, stimulated emission of electromagnetic waves by the metallic component of the optical connector plug 10 is suppressed.

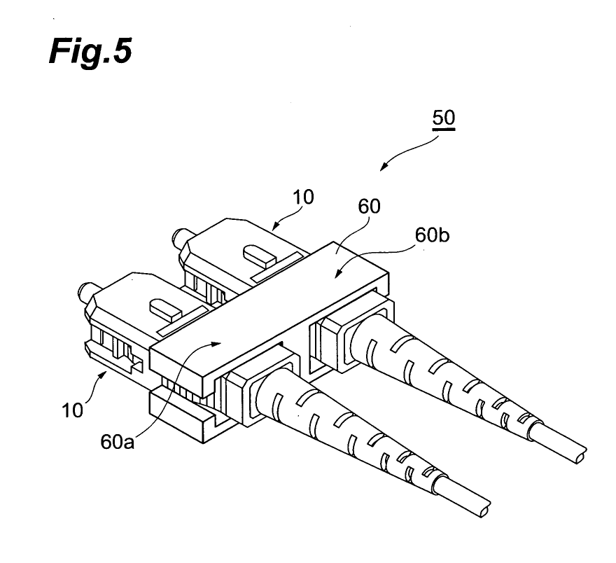

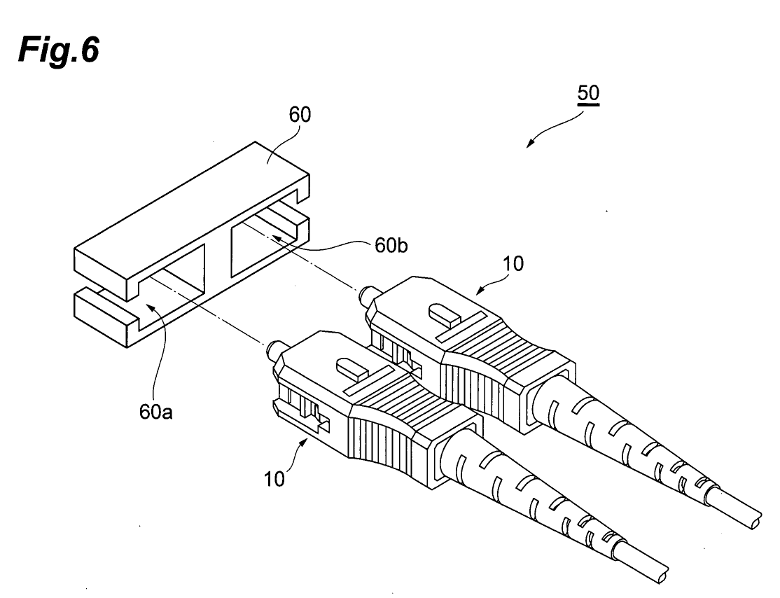

FIG. 5 is a perspective view of an optical connector device according to an embodiment of the present invention. FIG. 6 is an exploded perspective view of the optical connector device according to the embodiment of the present invention. In FIGS. 5 and 6, an optical connector device is illustrated. An optical connector device 50 shown in FIGS. 5 and 6 is used to transmit an optical signal from an optical communication module 100 shown in FIG. 1 or to transmit an optical signal from the outside to the optical communication module 100.

The optical connector device 50 comprises the first optical connector plug 10, the second optical connector plug 10 and an adapter 60 connecting and holding the first optical connector plug 10 and the second optical connector plug 10. The adapter 60 is comprised of an electromagnetic wave absorption material. The adapter 60 has a first holding part 60a to hold the first optical connector plug 10 and a second holding part 60b to hold the second optical connector plug 10.

Since the first optical connector plug 10 and the second optical connector plug 10 are held by the adapter 60, it is easy to insert and remove the optical connector device 50 from the optical communication module 100.

Note that the present invention is not limited to the embodiment described above, and may be subjected to various modifications. For example, in the embodiment described above, the plug frame 20, stop ring 22, and cover 30 have an electromagnetic wave absorption function, but any one of these components, or a part or all of the other components constituting the housing, may possess an electromagnetic wave absorption function.

As described above, when the optical connector plug is inserted into the receptacle, an opening in the receptacle is electromagnetically sealed by the housing, which includes an electromagnetic wave absorbent. As a result, the emission of electromagnetic waves from the opening in the receptacle is suppressed. Furthermore, since the electromagnetic waves emitted from the optical communication module are absorbed into the housing, stimulated electromagnetic wave emission is suppressed even when the interior of the optical connector plug comprises a metallic component.

The electromagnetic wave absorption material is preferably comprised of a resin containing an additive that has electromagnetic wave absorbency. By adding an additive to a malleable resin, a housing having an electromagnetic wave absorption function can be provided at low cost.

The additive may be a fine powder of iron, iron oxide, carbon, or stainless steel, or a fine powder of two or more materials selected from iron, aluminum, cobalt, and silicon. Note that the additive may be a fine powder of aluminum, cobalt, or silicon.

The ferrule is preferably comprised of a material containing nickel(Ni) as a main component. With this constitution, the nickel ferrule reflects electromagnetic waves into the interior of the optical communication module, and hence the emission of electromagnetic waves from the opening in the receptacle can be further suppressed.

According to the present invention, an optical connector plug which is capable of suppressing electromagnetic wave emission from an optical communication module is provided.

What is claimed is:

1. An optical connector plug inserted into a receptacle of an optical communication module, comprising:
an optical fiber;
a ferrule having a tubular form, said optical fiber being provided in an inner hole of said ferrule; and
a housing which is fitted into said receptacle, said optical fiber and said ferrule passing through the interior of said housing,
wherein either one of at least a part of said housing and at least a part of said ferrule is comprised of an electromagnetic wave absorption material.

2. The optical connector plug according to claim 1, wherein said electromagnetic wave absorption material is comprised of a resin containing an additive having electromagnetic wave absorbency.

3. The optical connector plug according to claim 2, wherein said additive is a fine powder comprised of a material selected from iron, iron oxide, carbon, and stainless steel.

4. The optical connector plug according to claim 2, wherein said additive is a fine powder comprised of two or more materials selected from iron, aluminum, cobalt, and silicon.

5. The optical connector plug according to claim 1, wherein said ferrule is comprised of a material containing nickel as a main component.

6. An optical connector device comprising:
the first optical connector plug according to claim 1;
the second optical connector plug according to claim 1;
an adapter connecting and holding the first optical connector plug and the second optical connector plug,
wherein the adapter is comprised of an electromagnetic wave absorption material.
